(19) United States
(12) Patent Application Publication
(10) Pub. No.: US 2010/0036720 A1
(43) Pub. Date: Feb. 11, 2010

(54) UBIQUITOUS INTENT-BASED CUSTOMER INCENTIVE SCHEME

(75) Inventors: Kamal Jain, Bellevue, WA (US); Brian James Utter, Seattle, WA (US); Zachary A. Apter, Seattle, WA (US); Alexander Gounares, Kirkland, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/101,831

(22) Filed: Apr. 11, 2008

(51) Int. Cl. G06Q 30/00; G06Q 10/00

(52) U.S. Cl. 705/14.13; 705/14.32; 705/14.39; 705/14.44

(57) ABSTRACT

System(s) and method(s) are provided to compensate an agent in exchange for the agent's intent in transacting with a service platform. Compensation can be effected in online and offline domains, and intent can be conveyed online or offline. Compensation is funded through advertisement spending, and advertisement impressions facilitate compensation delivery. The service platform that compensated the agent extracts intent through explicit or implicit expressions which can be collected online or offline. Offline expressions can be delivered through wearable indicia. Compensation can be delivered wirelessly offline or online to a device operated by the agent. Agent and agent's device(s) registration afford service platform to deliver adaptive compensation customized to the agent, and advertisement(s) with format and content optimized for the agent's device. To drive agent's commercial transactions, offline location services and online location information facilitate delivery of advertisement and associated compensation based in part on agent's intent and location.

### TECHNICAL FIELD

The subject specification relates to systems and methods for compensating a customer in online or offline domains through advertisement in exchange for the customer's intent in transacting with a service platform, wherein the intent can be conveyed online or offline.

### BACKGROUND

In conventional customer-service provider interaction, a customer or agent selects a service or goods provider based on an expectation that the provider would deliver relevant and competent service which would satisfy the needs of the agent. In addition, cost-benefit analysis generally contributes to the selection process, with the agent seeking the most value among available alternative. Once a selection is made—either a service provider is engaged in a commercial transaction, or a product is bought from a merchant—the agent conveys intent in accessing the service or utilizing a product. In response to the provided intent, an adequate selection of service provider or product generally leads to service or product satisfaction. In such a commercial paradigm, service providers and merchants typically compete for agent's intent by offering quality service and products while campaigning for brand recognition, awareness and loyalty, as well as service or product differentiation.

To drive transactions with customers and to develop brand recognition and loyalty, as well as product differentiation, service providers typically resort to reward or rebate systems to compensate a customer in exchange for a “binding” transaction, wherein the binding nature of the customer-service interaction is reflected in the need for the customer to commit funds, e.g., through a purchase, prior to receiving compensation. It is to be appreciated that typical rebate systems are product-centric rather than agent-centric. As a consequence, conventional systems generally reward disparate customers, who may have substantially divergent backgrounds, interests, and reasons for purchasing a product, with substantially the same reward. Thus, conventional reward systems fail to exploit customer diversity, even within the narrow group of customers that engage in a binding transaction.

It is to be further appreciated that “non-binding” rebate system information have also been pursued by service providers and merchants in order to increase service and product visibility. Yet, conventional non-binding rebates are also product-centric and generally tend to be low in value in view that no binding transaction is involved. Therefore, discouraging customers to lock-in in the rebate system; e.g., rebates go unclaimed, rebate-free products are consumed, and so on.

In addition, conventional binding and non-binding reward systems lack rich, detailed intelligence on customer(s) or agent(s) as said systems are product-centric. Conventional rebate systems therefore are rigid or quasi-static; namely, fail to adapt, or adapt poorly, to customer needs, interests, and wants. Moreover, conventional systems typically operate exclusively in the online domain or exclusively the offline domain, where the domains are primarily determined by the spaces in which the rebates are materialized. Furthermore, conventional reward systems have only marginally exploited the fluid access of customers to portable electronic devices and their interoperability.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject innovation provides system(s) and method(s) to compensate of an agent in online and offline domains in exchange for the agent's intent in transacting with a service platform, wherein the intent can be conveyed online or offline. Compensation is generally funded through advertisement spend incurred by an advertisement engine which can be internal or external to the service platform. In addition, advertisement impressions facilitate compensation delivery. To compensate an agent, the service platform extracts intent through explicit or implicit expressions or information, which can be collected online or offline. Cameras and sensors deployed by the service platform gather the implicit or explicit information offline while online expression are determined more conventionally through web-based content (e.g., queries, email and instant messages, online gameplay, . . . ). Analysis of collected information determines the agent's intent to various degrees of confidence. Offline expressions can be delivered through wearable indicia.

Compensation based at least in part on agent's intent can be delivered online or offline to a device operated by the agent. Offline delivery is generally conveyed through wireless links. Through agent registration and registration of a set of agent's devices, service platform can deliver adaptive compensation customized to the agent, display advertisement(s) with format and content optimized for the agent's device(s).

To drive agent's commercial transactions, service platform can (i) exploit offline location services like global navigation satellite systems and online location information, such as cookie files, to deliver advertisement and associated compensation based in part on both agent's intent and location; and (ii) by probe agent's response to the delivered advertisement and compensation in order to adjust the format and content to attain a desired response.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and novel features of the claimed subject matter will become apparent from the following detailed description of the claimed subject matter when considered in conjunction with the drawings.

### BRIEF DESCRIPTION OF THE DRAWINGS

FIG. 1 illustrates a block diagram of an example system that compensates an agent through ad spend in exchange for the agent's intent in accordance with aspects disclosed in the subject specification.

FIGS. 2A and 2B are, respectively, a realization-quadrant diagram indicating possible realizations for a (intent; compensation) realization 2-tuple and a block diagram of an example intent processing component and its functionality in accordance with aspects disclosed herein.

FIGS. 3A and 3B illustrate, respectively, a privacy component that regulates the scope of information collected during intent processing and an example intelligent component that facilitates intent extraction from collected information in accordance with aspects described in the subject specification.

FIG. 4 is a block diagram of an example advertisement management component that facilitates ad spend management and advertisement delivery according to aspects described herein.

FIG. 5 illustrates a block diagram of an example system that employs ad spend to compensate an agent in exchange of the agent's intent in engaging in a transaction with a service platform in accordance with aspects disclosed herein.

FIGS. 6A and 6B illustrate example systems that compensate a customer in exchange for the customer's intent in engaging in a transaction with a service platform in accordance with aspects described herein.

FIG. 7 illustrates an example system that drives customer consumption through location-adjusted compensation in an intent-compensation price incentive scheme according to aspects described in the subject specification.

FIG. 8 presents a flowchart of an example method for compensating an agent in exchange of the agent's commercial intent according to aspects set forth in the subject specification.

FIG. 9 presents a flowchart of an example method for compensating an agent through advertisement in exchange of agent's intent in transacting with a service platform in accordance with aspects described herein.

FIG. 10 presents a flowchart of an example method for conveying advertisement to an agent and funding compensation of the agent in return for the agent's intent in accordance with aspects of the subject innovation.

FIG. 11 presents a flowchart of an example method for driving consumer behavior through advertisement in accordance with aspects described herein.

FIG. 12 is a flowchart of an example method for adaptively conveying advertisement to an agent based at least in part on the agent's intent and the agent's location according to aspects described herein.

FIGS. 13 and 14 illustrate computing environments for carrying out various aspects described in the subject specification.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Further, the terms “component,” “system,” “module,” “interface,” “platform,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

As employed herein, the terms “agent,” “user,” “customer,” “player,” “participant” and the like generally refer to a human entity (e.g., a single person or group of people) that utilizes a software application (e.g., plays, participates in, or employs a computer-implemented game; or utilizes a utility software application like presentation-preparation software, data-analysis software, online investment and related business transactions, navigation software; and so on) and possesses access to computer-related communication infrastructure, computer-related systems, electronic devices, portable or otherwise, or any combination thereof. The aforementioned terms can be, and often are, hereinafter employed interchangeably.

Furthermore, the term “service” can refer to executing a software, such as using a toolbar or web-based email engine or search engine; retrieving information (e.g., status of a pending patent application, a proposal submission, immigration process, or package delivery); purchasing goods; making a payment (e.g. mortgage, rent, student loan, credit card, car, phone, utilities, late fees); taking a class at an online school; making an appointment with an offline provider (e.g., dentist, medical doctor, lawyer, hairdresser, mechanic); or registering for an online or offline conference. It should be appreciated that this listing of services is provided as a non-limiting illustration, as other services know to one of ordinary skill are within the scope of the subject innovation.

The term “intelligence” has two meanings: (i) it refers to information that characterizes history or behavior of a person or an entity, and to records of commercial and non-commercial activities involving a product or service, or a combination thereof, of the person or entity; and (ii) it refers to the ability to reason or draw conclusions about, e.g., infer, the current or future state of a system or behavior of a user based on existing information about the system or user. Artificial intelligence (AI) can be employed to identify a specific context or action, or generate a probability distribution of specific states of a system or behavior of a user without human intervention. Artificial intelligence relies on applying advanced mathematical algorithms—e.g., decision trees, neural networks, regression analysis, cluster analysis, genetic algorithm, and reinforced learning—to a set of available data (information) on the system or user.

As described in detail below, the subject specification discloses system(s) and method(s) to compensate an agent in exchange for the agent's intent in transacting with a service platform. Compensation can be effected in online and offline domains, and intent can be conveyed online or offline. Compensation is funded through advertisement spending, and advertisement impressions facilitate compensation delivery. The service platform that compensated the agent extracts intent through explicit or implicit expressions which can be collected online or offline. Offline expressions can be delivered through wearable indicia. Compensation can be delivered wirelessly offline or online to a device operated by the agent. Agent and agent's device(s) registration afford service platform to deliver adaptive compensation customized to the agent, and advertisement(s) with format and content optimized for the agent's device. To drive agent's commercial transactions, offline location services and online location information facilitate delivery of advertisement and associated compensation based in part on agent's intent and location.

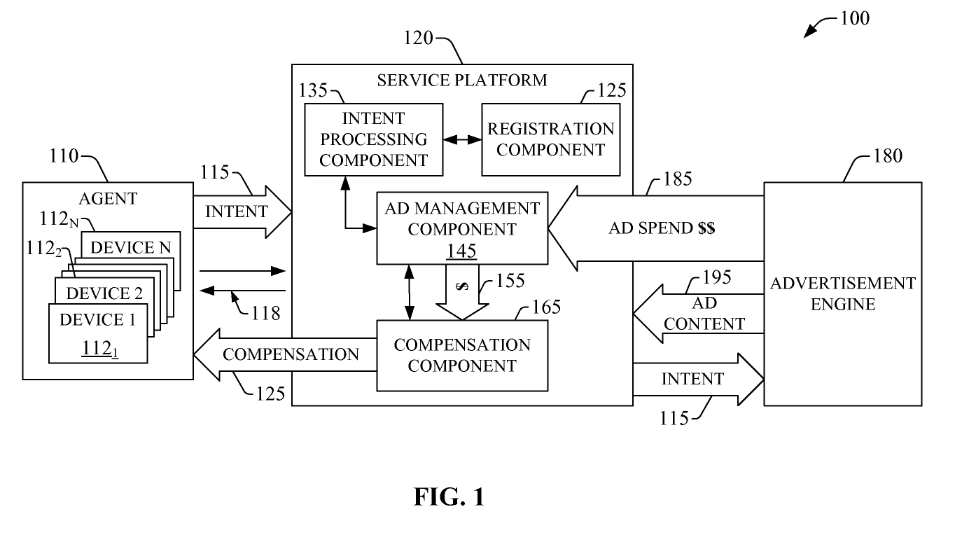

FIG. 1 illustrates an example system that compensates an agent through ad spend in exchange for the agent's intent in accordance with aspects disclosed in the subject specification. In example system 100, agent 110 conveys a commercial intent 115 to a service platform 120, which compensates agent 110, via compensation 125, in return for the agent's conveyed intent 115. It is to be appreciated that the commercial nature of agent's intent 115 lies in the fact that the intent 115 reveals the underlying purpose (e.g., purchasing a merchandise, selecting or subscribing to a service or product, utilizing a software application, requesting/accessing for specialized advise, and so on) of accessing service platform 120 and constitutes a key to receiving service from it—Agent 110 discloses intent 115 based on an expectation that the service platform 120 may be relevant to the agent's needs. By effecting such compensation, service platform 120 creates a monetary differential in favor of the customer, e.g., a user price incentive, and can distinguish itself from competitors. Such a distinction can occur at different levels: brand recognition, service/product demand, engagement of early adopters, potential for formation of business partnerships, and so on.

Service platform 120 is neither limited to a specific industry nor a specific service. Additionally, industry or service is neither limited services consumed online (e.g., through the Internet) nor offline (e.g., access to the service does not hinges on access to the Internet). A desirable characteristic of a service, or product obtained through service platform, is that the service is primarily accessed regularly (e.g., on a daily basis). Agent's intent 115 and the service provided, or goods delivered, by service platform 120 typically are interdependent. Online service platform.—In an aspect, service platform 120 can be an online search engine, wherein the search query embodies the agent's intent in receiving a list of search results. Moreover, customer intent 115 can be related to searching for a provider or particular goods or services, and a plurality of providers may compete for knowledge of such intent (e.g., by offering rewards/incentives) in order to be presented to the customer in a favorable forum/light that will facilitate a commercial transaction transpiring between the customer and the service or product provider. In another aspect, service platform 120 can be an online portal of a technical journal, where an agent looking to retrieve a specific article provides a citation to the article (e.g., intent 115) and the publisher responds by presenting or delivering the article to the user. In another aspect, service platform 120 can be an online software application service wherein an interface customized for an agent provides the functionalities of a specific software application (e.g., payroll and benefits applications; business development and program management applications, simulation applications; online gaming applications; and so on) for a service fee. In yet another embodiment, service platform 120 can be social networking website, wherein the service platform facilitates (i) customer expression through deployment and maintenance service(s) of a webpage, and (ii) interactions among disparate customers. It should be appreciated that various additional online services can be contemplated.

Offline service platform.—Substantially any merchant or service provider that operates offline can adopt the intent-compensation paradigm described herein; for instance, car and motorcycle dealers, department stores, coffee shops, liquor stores, bookstores, and so on.

Agent 110 can utilize various devices 112₁-112_{N}, which can either be wired or wireless (e.g., a cell phone, a laptop, tethered computer, vehicular navigation device, game console, or personal digital assistant) and with a display area that can be accessed interactively or otherwise, to convey intent 115. Based at least on disclosed information, the conveyed agent's intent 115 can be classified in at least two broad categories: (a) explicit expression of intent, and (b) implicit expression of intent. To convey intent and participate in the intent-compensation commercial scheme established in example system 100, an agent registers with system platform 120 through registration component 125, which gathers agent intelligence during the registration process. In addition, the agent also registers the set of devices 112₁-112_{N}. Registration of devices 112₁-112_{N} facilitates delivery of compensation and customized information related therewith such as advertisement, compensation opportunities, merchants affiliated with service platform 120 that participate in the intent-compensation commercial model, and so on. In addition to the benefits for the user in connection with participating in the intent-compensation price incentive model of service platform 120, registration with service platform 120 is also advantageous as agent intelligence can be collected at the time of registration, and utilized by service platform 120, for example, for targeted marketing campaigns.

Service platform 120 also includes an intent processing component 135 that obtains agent's intent 115 through a variety of instruments or mechanisms (e.g., portals, pop-up windows, queries, statements, utterances, inferences, extrinsic evidence, historical data, machine learning systems, webcams, charge-coupled device (CCD) cameras, microphones, feature harvesting systems, and so forth). Intent processing component 135 can evaluate the veracity of the agent intent 115 and generate confidence metrics associated therewith. Such confidence metrics can be factored in connection with allocation of compensation 125. It should be appreciated that, unlike conventional couponing and rebate schemes, intent processing component 135 determines or infers customer intent dynamically (for example via Internet or wireless communications—e.g., search engines and cellular telephones are examples of platforms suitable to deploy various embodiments described herein), and utilizes the determined intent to facilitate joining the agent with advertisers and, alternatively or additionally, suitable service providers (not shown) affiliated with service platform 120 in connection with maximizing utility to the user or the service provider. In addition, intent processing component 135 provides agent 110 with bargaining power through solicitation of intent information (the solicitation can occur through a wireless, wired, or hybrid communication link 118) which conventionally was often provided for free by an agent (e.g., agent 110). As a result, agents can increase buying power or wealth through leveraging off the value of their respective intent information. Furthermore, a filtering process can be achieved where unmotivated service providers or merchants, or respective advertiser, are not exposed to the agents thereby mitigating spam-like solicitations. An embodiment for intent processing component is discussed below.

In an aspect, compensation 125 can be provided through advertisement; e.g., ad spend 185 and ad content 195 generated by advertisement engine 180. System platform 120 includes an advertisement management component 145 that utilizes a known (through explicit intent expression) or established (e.g., extracted from an implicit expression) agent's intent 115 to generate advertisement impressions that carry a compensation in exchange of the customer intent. Compensation can be accessed through advertisement in multiple manners: (1) Advertisement exposure. In this scenario, the advertisement impression is conveyed to the user in the form of direct compensation, wherein the advertisement is a “conduit” for delivering the compensation. (2) Advertisement instantiation. A compensation is received by instantiating the advertisement impression; e.g., by following instructions in the advertisement such as for example, responding to an online or telephonic survey; visiting an online webpage or an offline showroom, watching a movie trailer or portion of a movie soundtrack, and so on. (3) Advertisement-driven action. Compensation is the result of a specific commercial transaction between the agent and the advertiser. It is to be appreciated that intent-driven advertisement is intrinsically targeted, thus the likelihood of an agent engaging in a transaction with the advertiser or service platform is substantially high. The likelihood of an agent take action can be biased via the level of provided compensation; namely, advertisement management component 145 can present advertisement that offer a compensation that is above a known or inferred engagement threshold associated with the agent that conveys the intent 115. In an aspect, this mode for accessing compensation can supplement (1) or (2).

To finance compensation (e.g., compensation 125) to a customer (e.g., agent 110) in exchange for the customer's intent (e.g., intent 115), service platform 120, through ad management component 145, can direct funding 155 arising from advertisement spend 185 to a compensation component 165. The amount of funding 155 directed towards compensation is typically determined according to a financial model that ensures a zero-sum scenario with respect to (a) ad spend directed towards compensation, (b) ad spend for advertising, and (c) credit awarded for advertising to advertisement engine 180 by service platform 120 over an advertisement cycle (e.g., a week, a month, a quarter, . . . ). It is to be noted that (c) can be viewed as funds that “prime the pump” for an advertisement engine 180, by providing subsidies for advertisement campaigns in emerging markets; focused on new products or services; or based on new advertising techniques, resources and media.

Once an advertisement model for compensation delivery is selected; based at least in part on the nature—explicit or implicit expression—of the intent 115 received by service platform 120, the available intelligence on the originating agent, etc.; and consistent action has been taken by a customer (e.g., agent 110), compensation component 165 delivers compensation 125. To that end, compensation component 165 performs multiple tasks, which comprise accounting, managing fraud mitigation, and retaining records associated with compensation. In an aspect, compensation component 165 can manage issued compensation like adopting changes to face-value of compensation 125; for instance, conferring a promotional value, typically above average or generally awarded value, to the compensation 125 if specific actions are taken by an agent like responding to an online product survey or visiting an offline store show-room within a specific period of time. In another aspect, compensation component 165 can determine specific compensation according to agent intelligence available to service platform 120, in order to mitigate customer attrition, or increase the quality of information associated with intent (e.g., increase the instances in which intent is conveyed via explicit rather than implicit expression). In yet another aspect, compensation component 165 can broker partnerships with disparate online or offline merchants that may be affiliated with service platform 120.

It is to be appreciated that through a set of registered mobile devices (e.g., devices 112₁-112_{N}), compensation component 165 can provide compensation either online or offline. Registration of devices that can receive compensation facilitates the optimization of a device's resources when conveying an advertisement that carries compensation. Furthermore, a set of devices that are utilized at the time an eligible action is undertaken by agent 110 can drive the compensation type. For example, agent 110 utilizes an online service to trade stocks (a possible embodiment of service platform 120) in a laptop computer (e.g., device 112₁) while the agent 110 listens to music in a Zune® digital media player—that agent 110 is listening music in a Zune® device (e.g., device 112_{N}) can be gleaned from information collected by webcam operating on the agent's laptop computer and conveyed to intent processing component 135—at a specific instance agent 110 buys stock from an entertainment company. The system platform, based on the transaction, available intelligence about the user, and the fact that the user is listening to a Zune® device, result in a digital song delivered to the user email inbox (and possibly a notification to the agent's cell phone) as a compensation for conveying intent to the stock trading system. The illustrative scenario described hereinbefore displays a central advantage of the intent-compensation price incentive scheme herein disclosed with respect to conventional system: Compensation can be synergistically customized based on context and behavior, rather than established solely on user intelligence or eligible action.

As illustrated above, compensation 195 has monetary value. Monetary value can be effected (i) directly, e.g., monies are deposited in a compensation account (not shown in FIG. 1) that belongs to agent 110, or debt carried by agent 110 in, for example, credit card(s) is reduced by a specific amount—it should be appreciated that such credit card(s) can be issued or managed by service platform 130 or an affiliated lender (e.g., service provider) which makes debt reduction substantially more affordable and advantageous to the service platform 120. Direct payments can be electronic and effected in real time, via a wireless transmission effected through communication 118 directly to a debit/credit card registered by agent 110. The magnitude of a direct payment awarded to agent 110, as compensation 125, is generally a function of multiple variables: enrollment longevity, income bracket, educational level, professional activities, leisure activities, and demographics factors. Based at least in part on such parameters, compensation component 165 can determine an adequate compensation for agent 110. It is to be appreciated that agent 110 can be notified to one or more of the agent's registered devices that a direct payment incentive has been awarded; for example, in an online interaction a user can receive an instant message describing the type and magnitude of the compensation, or in an offline interaction the user can receive a short message service (SMS) message to the agent's cell phone, pager, or any other registered device (e.g., device 112₁-112_{N}).

Monetary value can also be effected (ii) indirectly, such as through reward points, service-specific points, platform-specific points, virtual monies or points, e.g., Microsoft® Points or substantially any other denomination, that can be used to claim a rewards either online or offline. In addition, agent 110 can be compensated with generic points (or substantially any other tokens associated with materializing a compensation) that facilitate claiming products or merchandise of different types and scope. Points, generic or otherwise, can be perishable or perennial, and can be transferred to a second agent (not shown). It should be appreciated that, in an aspect, generic points can be managed dynamically by service platform 130, adopting promotional value to drive a specific product or service campaign, or changing scope as a function of the point bearer (e.g., a compensated agent like agent 110). An alternative or additional form of indirect monetary compensation can be effected through digital merchandise like songs; ring-tones; movies; pictures; books; magazine articles, technical or otherwise; greetings cards; games, console-based and online, single-player or multiplayer; software application add-ons such as Microsoft® Visio® stencils or custom font sets; foreign-language dictionaries; maps, secret passages, and answers to riddles for second worlds relevant to role playing games, and so on.

Operation of compensation component 165 is discussed in greater detail below.

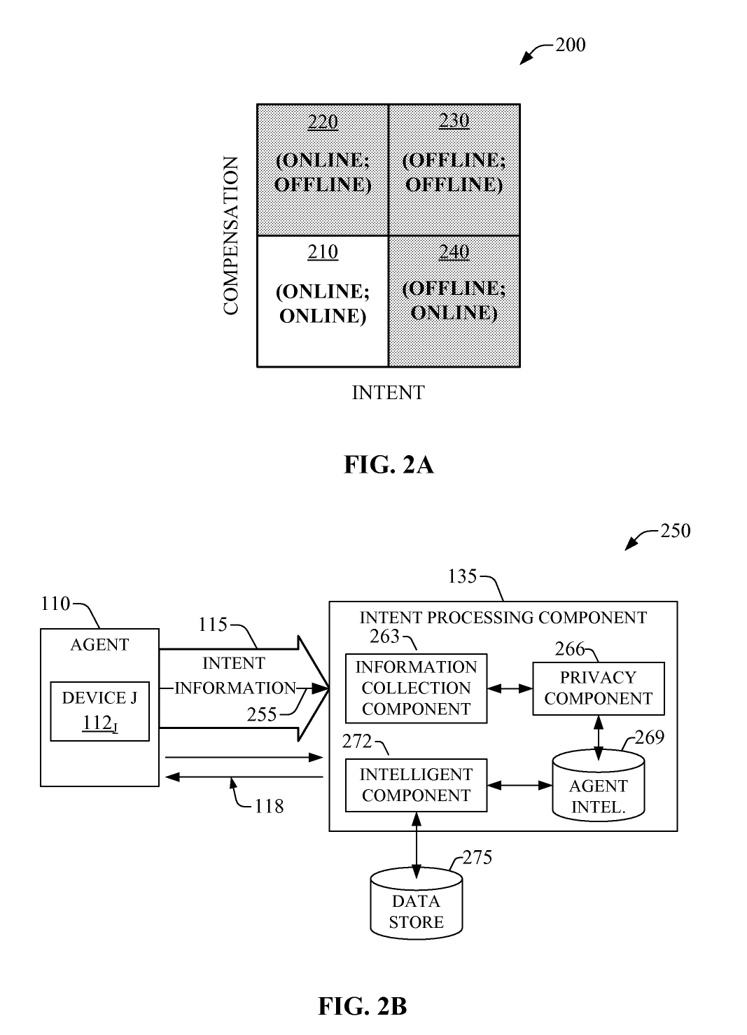

FIG. 2A depicts a realization-quadrant diagram 200 for the 2-tuple (intent; compensation). The intent-compensation price incentive model herein disclosed contemplates online and offline (illustrated in grey tone) scenarios. Such scenarios can be represented in a through a realization-quadrant for the 2-tuple (intent-compensation) that reflects the “location” wherein intent is conveyed and compensation is realized. A first realization-quadrant 210 corresponds to both intent and realization conveyed online. Such scenario typically entails an agent (e.g., agent 110) that utilizes an online based service platform (e.g., a search engine, a stock trading website, an online gaming website). The agent conveys intent through utilization of the online service, the intent can be explicit such as for example requesting quotes for car insurance in an insurer's website, or submitting a text passage for translation from a first language to multiple languages. In response to receiving intent, the online-base service platform delivers compensation (e.g., compensation 125) to the customer that typically includes digital content that claimed online.

A second realization quadrant 220 corresponds to intent that is received online by a service platform, which can either be a web-based service or an offline service—in either situation intent is received online—and compensation received offline. Illustrations of realization quadrant 220 include online portals to arrange reservations of offline services such as online reservation of hotels, flights, and rental cars, with compensation comprising upgrade of accommodations, sit selection, or car selection; online purchases of tickets for offline events, online reservation of books in a catalog for offline pick-up. It should be appreciated that in the foregoing examples of realization quadrant 220, an indication or notification of compensation can be delivered online, however compensation is effected offline; an updated accommodation is taken, an upgraded seat is utilized during a flight, and so on.

A third realization quadrant 230 corresponds to intent conveyed offline and compensation delivered offline. In this realization an agent conveys intent through a set of actions offline rather than by exploiting an Internet connection. Typically, intent that is conveyed offline is of the implicit type, wherein information surrounding the actions of an agent is collected and intent is inferred through intent processing component 135. It is to be appreciated that intent processing component 135 can collect information relevant to extracting intent from an agent's actions. Various tiers of information can be utilized to determine an agent's intent (e.g., intent 115). For example, detecting an agent (e.g., agent 110) entering a merchant store, such as a coffee shop, provides with a low-level information that conveys intent; namely, the agent intends to engage in a transaction with the merchant responsible for the store. It should be appreciated that a determination that an agent has entered a store can be complemented with intelligence associate with the agent: If the agent each morning enters the coffee shop and leaves with a cup of coffee, it can be inferred that after an agent has entered the coffee shop in the morning, the associated intent is to order and buy a cup of coffee. It is to be noted that the latter is an elementary example of training that an intent processing component can undergo to learn to extract intent from implicit expressions of intent ascribed to an agent. When a merchant that manages the coffee shop is an offline service platform that utilizes an intent processing component (e.g., component 135) to determine an agent's intent to compensate the in exchange of his or her intent, then a the merchant can issue a discount (e.g., a compensation) once the agent enters the store or buys merchandise sold therein.

A fourth realization quadrant 240 corresponds to intent conveyed offline and compensation delivered online. In this realization intent is conveyed as discussed in connection with realization quadrant 230 and compensation is delivered online in substantially the same manner as discussed in connection quadrant 210.

FIG. 2B illustrates a block diagram 250 of an example intent processing component 135 and associated example functionality. Intent processing component 135 receives intent 115 from an agent 110. Intent 115 can be gleaned from information 255 received from agent 110 in connection with a commercial intention in engaging a service platform 120 (e.g., a merchant, a service provider, or a content provider). Information 255 is received by intent processing component 135 through communication link 118. As indicated above, communication link 118 can be substantially any type of communication link, either wired (e.g., a T-carrier like T1 phone line, an E-carrier such as an E1 phone line, a T1/E1 carrier, a T1/E1/J1 carrier, a twisted-pair link, an optical fiber, and so on) or wireless (e.g., Ultra-mobile Broadband (UMB), Long Term Evolution (LTE), Wireless Fidelity (Wi-Fi), Wireless Interoperability for Microwave Access (WiMAX), etc.), or any combination thereof. In addition, information 255 can be intrinsic, e.g., conveyed by agent 110, or extrinsic, wherein intent processing component 135 collects information associated with agent 110 actions with respect to a service platform. Information 255 is received by information collection component 263. In the case of extrinsic information 255, the information collection component 263 can exploit a variety of instruments and devices such as web cameras, infrared-visible cameras, CCD cameras sensitive to specific radiation frequencies, microphones, biometric pads, physiological sensors, positioning systems (e.g., Global Positioning System (GPS), Galileo, GLONASS), and associated wired and wireless transceivers that can communicate the gathered information.

To ensure privacy integrity of an agent's actions, a privacy component 266 regulates the information that can be collected to extract agent's intent. In an aspect, privacy component 266 maintains an agent's privacy according to privacy settings established by the agent. Privacy component 266 also manages how records of collected agent's actions are stored within an agent intelligence store 269. Functionality of privacy component is discussed in greater detail below.

Collected information associated with agent's actions that are compatible with privacy regulations, or policies, can be utilized by intelligent component 272 to infer agent's intent 115. Analysis and feature or pattern mining of information can be implemented by intelligent component to extract intent. In addition, intelligent component 272 can utilize supplemental data that can facilitate intent inference, and interpretation of agent's behavior according to the information gathered by information collection component 263. Supplemental data can reside in a data store 275, which can include data from experiment(s) and simulation(s) on behavior, demographic influences on behavior and associated intent (e.g., agents with disparate backgrounds may convey a same intent through disparate actions), etc. Moreover, supplemental data can include data generated by intelligent component 272 in prior instances of intent processing and extraction. Operation of intelligent component 272 is described in greater detail below.

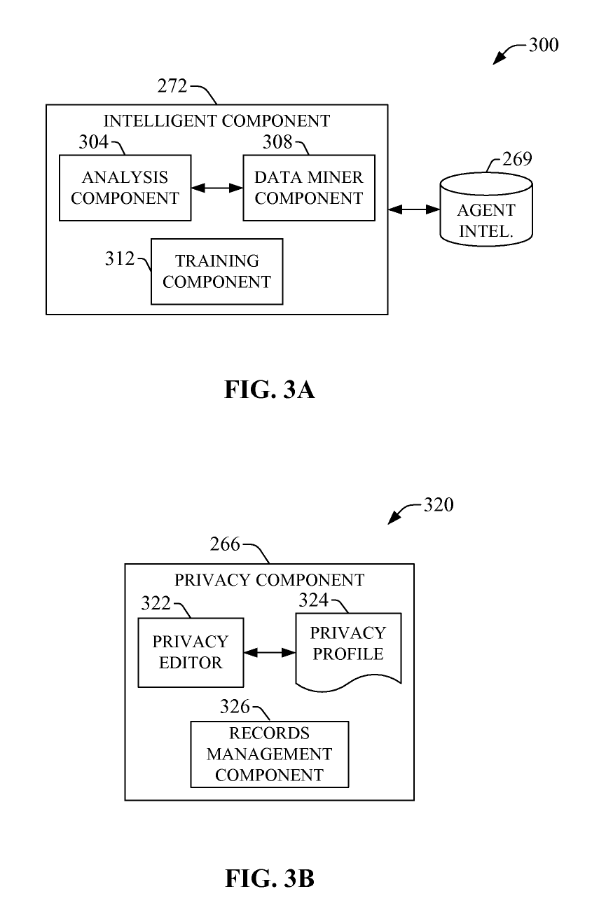

FIG. 3A illustrates an example intelligent component 272 that can reason or draw conclusions about agent's intent 115 based at least in part on collected information 255, and on agent intelligence (e.g., agent's information in storage 269) and supplemental data 275 available to intent processing component 135. Intelligent component 272 can generate a probability distribution of specific states of agent's intent in engaging in a transaction with service platform 120 without human intervention. To infer agent's intent 120, intelligent component 235 relies on artificial intelligence techniques, which apply advanced mathematical algorithms—e.g., decision trees, neural networks, regression analysis, principal component analysis (PCA) for feature and pattern extraction, cluster analysis, genetic algorithm, and reinforced learning—to a set of available (as it can be determined by privacy component 266) information associated with agent 110.

In particular, the intelligent component 235 can employ one of numerous methodologies for learning from data and then drawing inferences from the models so constructed, e.g., Hidden Markov Models (HMMs) and related prototypical dependency models, more general probabilistic graphical models, such as Dempster-Shafer networks and Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein.

Analysis component 304 can execute at least a portion of the algorithms cited above for inferring agent's intent 115. Data miner 308 can further support analysis of information through data segmentation, model development for agent's behavior simulation(s) and related model evaluation(s).

FIG. 3B illustrates an example privacy component 315 that can be a part of intent processing component 135. Privacy component 266 can comprise a privacy editor 322 which facilitates establishing a privacy profile 324. Privacy editor 322 can exploit a graphical user interface (not shown) to facilitate an agent (e.g., agent 110) to opt for a predetermined level of privacy with respect to the information that can be collected in connection with the agent's actions with respect to implicit expression(s) of intent, e.g., an agent standing in line to access a movie theater—plausible intent: to watch a movie and possible consume products from a theater's concession stand. It is to be appreciated that privacy editor 322 can be provided through a webpage maintained by a service platform 120. It should be appreciated that privacy editor 322 can be accessed asynchronously and as often as an agent 110 desires. In addition, agent 110 can be prompted to update his or her privacy profile 324 prior to information being collected to determine agent's intent. Privacy profile 324 can be encrypted to further ensure privacy integrity. It should be appreciated that an agent 110 can categorize, or segment, its privacy settings in order to establish the information that can be collected in different instances or regarding disparate merchants affiliated with service platform 120. Accordingly, an agent 110 can allow disparate merchants, or service platforms, different degrees of information collection.

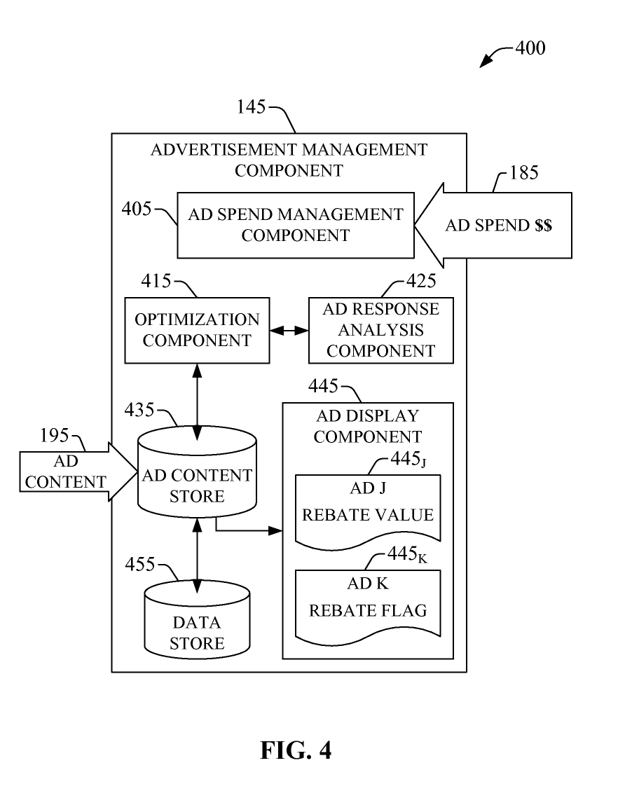

FIG. 4 illustrates an example advertisement management component 145 that facilitates management of ad spend and delivery of advertisement. Illustrative component 145 comprises an ad spend management component 425 that receives and manages advertisement spending 185 from advertisement engine 180. As discussed above, a portion of the received ad spend 185 is directed to compensation of an agent in exchange for the agent's intent in engaging in a transaction with service platform 120. Advertisement management component 145 also includes an optimization component 415 that (i) adjusts advertisement content delivered to an agent, and (ii) optimizes advertisement format in accordance with a registered device utilized by the agent. It is to be appreciated that optimization of advertisement format for according to the media resources of a particular device (e.g. a device with limited display real state, or a device with limited sound capabilities such as a navigation system) provides the agent with a richest advertisement experience available to the device and thus increases the likelihood that the agent responds to the advertisement.

Optimization of advertisement format and delivery can rely on input provided by ad response analysis component, which can monitor response metrics for the agent when presented with a specific type of advertisement. For example, it can be determined that an agent is more likely to effect an advertisement-driven (e.g., respond to a survey, follow a link to a beta release of a website, buy a merchandise) action when the presented advertisement contains age-appropriate music or sound indicia rather than when the advertisement is solely based on imagery. As another example, it can be measured that an agent responds more favorably to advertisement instantiation when cinema, television, or music stars appear on the delivered advertisement endorsing a product or service. As yet another example, typically at check out, a cashier at a supermarket issues paper coupons for specific merchants based on the purchased goods, while for a segment of customers paper coupons are useful for a disparate segment, e.g., early adopters, a soft version of the coupon can increase likelihood of coupon redemption; accordingly, in an aspect of the subject innovation, an information collection component can gather information via a set of cameras and microphones deployed at the cashier and an analysis component can identify the customer with a specific customer segment, subsequently a coupon format optimized for the customer segment is delivered; e.g., an indication to print a coupon is conveyed to the cashier or a coupon is wirelessly conveyed to customer's smart phone. It should be appreciate that compensation, or related advertisement, adaptation provides at least two advantages with respect to conventional “one format fits all” couponing systems: (a) increases likelihood of a posteriori engagement as a result of customized delivered compensation, and (b) magnitude of the coupon can be adjusted contextually in an agent-centric manner, rather than determined based on purchase-centric metrics, e.g., number of specific purchased items.

It is to be appreciated that optimization component can autonomously generate new advertisement content leveraging off existing content in ad content store 435. Generation of new ad content can be driven by analysis provided by ad response analysis component. In an aspect, generation of digital ad content can exploit metadata adaptation of existing content or edition (e.g., addition of a soundtrack, icons, images, etc.) of such content.

Advertisement management component also includes an ad display component 445 that presents an agent with intent-compensation incentive advertisement. Advertisement conveyed through ad display component 445 can be rendered at stationary offline points or on substantially any device 112₁-112_{N} registered by agent 110. Displayed advertisements can present a compensation flag (e.g., 445_{K}) or an exact-rebate-value (e.g., 445_{J}) flag. It is to be appreciated that rebated value can be adapted to specific characteristic of the agent to which the advertisement is presented to. Advertisements can be conveyed in multiple formats (e.g., image-based (e.g., banners), text-based, sound-based, or a combination thereof) depending on the media resources available to the device (e.g., device 112_{N}) in which the advertisement is rendered, or available to an advertisement “dock” (e.g., an outdoor electronic banner) for display of intent-compensation advertisements offline. In one embodiment, ad display component 445 can be employed to notify agent 110 of advertised compensation after agent 110 is no longer utilizing service platform 120. In such embodiment, ad display component 445 can communicate advertisements that were previously presented to agent 110 to substantially any of the devices 112₁-112_{N}. Such embodiment adds value for the service platform and the advertiser as it increases the lock-in of the user with the service platform 120 by increasing the likelihood of repeat engagements, in which new advertisements can be presented to agent 110.

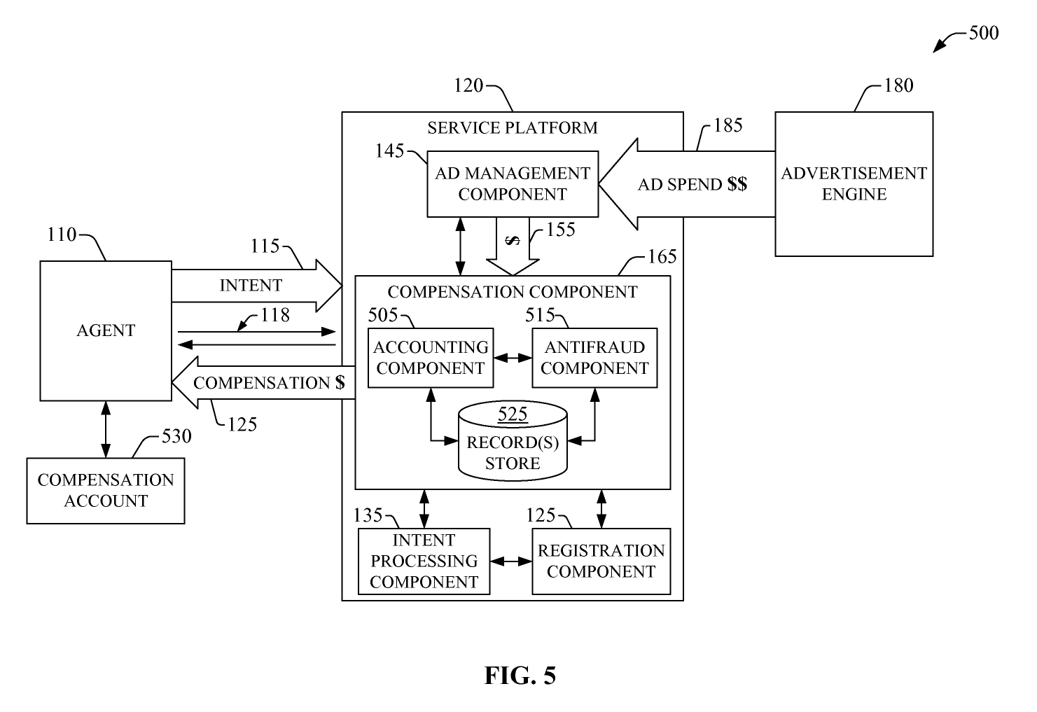

FIG. 5 illustrates a block diagram of an example system 500 that employs ad spend to compensate an agent (e.g., agent 110) in exchange of the agent's intent in engaging in a transaction with a service platform (e.g., service platform 120). As discussed above, compensation typically is effected through specific responses to advertisement events (e.g., advertisement exposure, advertisement instantiation, or advertisement-driven action like an ad-click or a purchase). In system 500, service platform 120 receives a payment 185 to display advertisements for advertisement engine 180 in accordance with a determined agent's intent 115. In an aspect, advertisement engine 180 can be a part of a merchant which utilizes service platform 120 as an advertisement service or broker. In another aspect, advertisement engine 180 can be an advertisement intermediary between service platform 120 and a set of disparate merchants. In yet another aspect, advertisement engine 180 can be an integral part of, and managed by, service platform 150. In a further yet aspect, ad management component 145 processes ad spend 185, and splits it in two streams: A portion of monies 185 are retained as advertisement revenue for service platform 130 or directed toward a revenue account (not shown), and a remaining portion of monies 185 are directed towards agent compensation 125. As discussed above, compensation monies can be utilized to award an agent (e.g., agent 110) a direct payment 560, or can be employed to fund merchandise and products employed to compensate the agent and associated with service platform 120 or disparate manufacturers or service providers (not shown) affiliated with the service platform 120. Compensation of an agent (e.g., agent 110) through a direct payment or an allocation of reward points can be delivered (via communication link 118) to a compensation account 530 that belongs to the agent. It should be appreciated that while a single agent 110 is illustrated in diagram 500, multiple customers can be included in agent 110.

As discussed above, compensation 125 typically has monetary value; thus, to ensure compensation is adequately awarded, accounted for, and recorded, compensation component 165 includes an accounting component 505, an antifraud component 515, and a records store 525. Accounting component 505 can account for payments, retain compensation records in record(s) store 525, and monitor a current level of compensation for the agent to ensure, for example, compensation fails to surpass a compensation limit. In an aspect, accounting component 505 can conduct the accounting of points (e.g., generic points, reward point, or platform specific points like Microsoft® Points) issued by compensation component 165 and associated with a specific compensation event. In addition, the compensation event can be recorded. Generally, compensation records can include type and amount of compensation delivered to an agent 110, and can augment available intelligence on agent 110. Retaining records of delivered compensation facilitates to resolve disputes that can arise from registered agents claiming an eligible uncompensated transaction with an advertiser. In a dispute, service platform 120 can either directly refund the agent setting forth the claim of unpaid compensation, or start an audit of the intent-based transaction to confirm its veracity.

Antifraud component 515 manages security features that mitigate fraudulent exploitation of compensation and preserve compensation records integrity. Antifraud component can exploit various resources such as agent intelligence stored, for example, in agent intelligence store 269, data stored in memory 455, intelligent component 272 and optimization component 415, and so forth. Moreover, antifraud component 515 can implement detection of biometric markers (e.g., voice signature, face-feature recognition like recognition of scars, moles, freckles, eye color and iris structure, and so on) in online and offline compensation that can facilitate biometric-based verification to ensure that an intended customer indeed received an intended compensation. Antifraud component 515 can provide substantially all functionality associated with probing biometric features (e.g., cameras for bio-feature recognition, fingerprint pads, iris scanners . . . ), encrypting/decrypting online compensation, etc; yet, utilization of resources available to other system components (e.g., intent processing component 135) can also be exploited.

In addition, antifraud component 515 can ensure intent is actually conveyed by a legitimate agent, e.g., agent 110, instead of an automated script that emulates an agent. Mitigation of automated generation of counterfeit intent can be particularly relevant in realizations in which intent is conveyed online (e.g., quadrants 210 and 220). In view of the intent-based antifraud component 515 can implement variations of Turing tests to discern whether a counterfeit agent is conveying intent 115; for instance, based on information collected by intent processing component 135, antifraud component can present a suspicious agent with advertisement unrelated to the submitted conveyed to referral component 135, antifraud component 515 can pose questions associated related with collected information professional and whose expected answers are inferred with a high degree of confidence and an automated source of intent is highly likely to fail answering correctly. In another aspect, antifraud component 515 can determine whether incoming intent (e.g., intent 115), or associated information, from a specific agent (e.g., agent 110) obeys a specific pattern; for example, intent is conveyed periodically, seasonally (e.g., at specific times of a day, a week, a month), and so forth.

Antifraud component 515 can mitigate fraudulent compensation by systematically reducing the face-value of delivered compensation for reiterative intent that is determined to be likely fraudulent. A characteristic relaxation time for compensation value can be determined according the degree of confidence on the illegitimate nature of the received intent.

In instances in which compensation relies on an advertisement-driven action that allows an agent 110 to effect the action during a specific period of time, antifraud component 515 can generate a uniquely linked (e.g., via an N-bit (N a positive integer) key) token pair to identify agent 110 and the action and an associated advertiser that requests the action. The token pair facilitates recognizing the agent once the ad-driven action is effected and delivering the ensuing compensation (e.g., compensation 125). It should be appreciated that compensation component can convey agent's identification via communication link 118. A record of the notification, and the associated token pair, can be retained in record(s) store 525 or in agent intelligence memory 269.

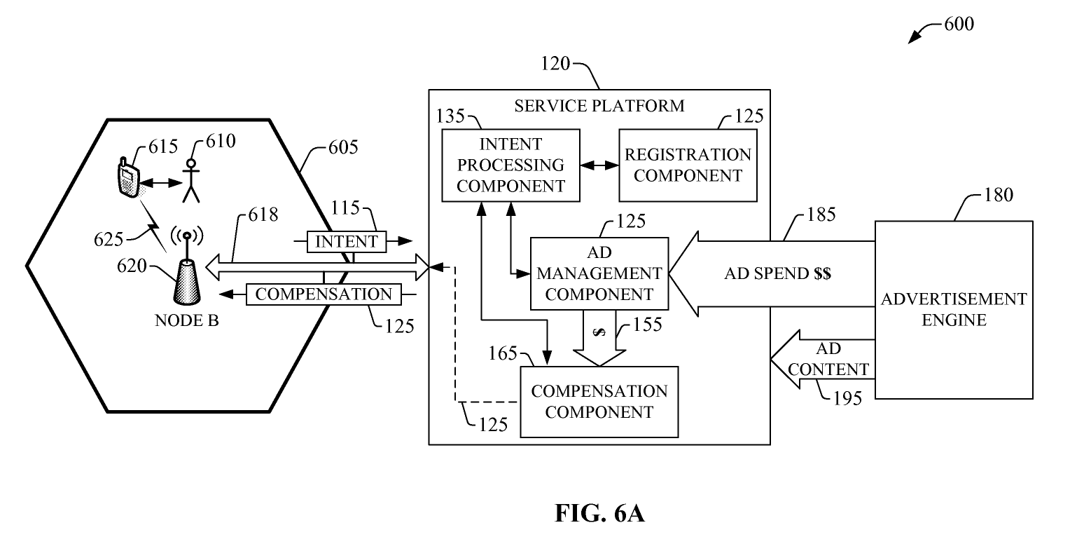

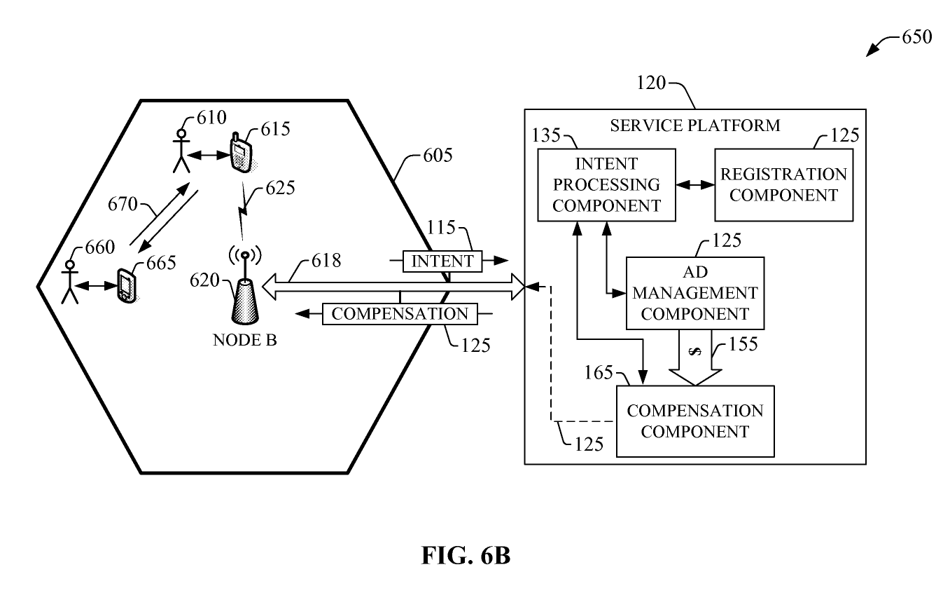

FIG. 6A is an example system 600 that compensates a customer 610 in exchange for the customer's intent in engaging in a transaction with a service platform 120. In system 600, communication of intent 115, or information associated therewith, is conveyed wirelessly, via a wireless device 615, by a customer 610 located in an offline area 605. Node B 620 (which can be a part of information collection component 263 residing in service platform 120) provides wireless communication coverage to a service cell 605, which is illustrated as a typical hexagonal service cell, even though specific geometry of coverage area can vary. The wireless device 615 typically is a device that has been registered with service platform 120 through registration component 125. In case a device (e.g., wireless device 615) is not registered with a service platform (e.g., service platform 120), registration of the device can be conducted at the time of engaging in an initial transaction with the service platform utilizing the unregistered device. Device registration information can be stored in agent intelligence store 269, and typically facilitates optimization of advertisement and compensation delivery to the media resources (e.g., display real state, sound capability, or personal area network connectivity) available to the device. Optimization of advertisement associated with compensation in exchange can increase customer lock-in specially in compensation that relies on advertisement-drive action (e.g., a purchase, a click to access a vendor website, a phone call or a text message to a customer center, . . . ). Moreover, by optimization of content as well as format of advertisement and compensation ensures the fidelity of delivered content regardless of the characteristics of the wireless device utilized by customer 610; the latter efficiency with respect to quality of service renders the innovative intent-compensation system described herein more advantageous compared to conventional reward or couponing systems.

A base station, or node B 620, maintained by service platform 120 or by an affiliated provider of wireless service, can receive the customer's intent 115 (e.g., explicit expression of intent), or associated information (e.g., implicit expression of intent), and covey compensation 125 via wireless link 625. Communication among node B 620 and device 615 can be effected according to various wireless communication protocols (e.g., LTE, UMB, WiFi, WiMAX, and the like). Base station 620 can communicate with service platform 120 via communication link 618 which typically is a wired link, even though portions of link 618 can be wireless. As an example, a wired (e.g., coaxial, twisted-pair, optical fiber) link 618 can be a backhaul communication link 488, which facilitates communication between service platform 120 with node B 620 via an IP-based, packet switched protocol.

It is to be appreciated that the afforded offline mobility of intent-compensation price incentive system 600 allows customer 610 to claim a reward or compensation 125 in offline venues, which can be affiliated with service platform 120, or can accept “points” currency (e.g., Microsoft® Points) or reward points issued by the service platform 120. As discussed next, the dynamic and adaptive aspects of the intent-compensation price incentive model described herein, when combined with the mobility afforded through wireless communication (e.g., via wireless link 625) affords service platform 120 the commercial framework to drive, or bias, the consumption habits of customer 610 dynamically through advertisement backed compensation 125.

In another aspect of compensation offline, agent's explicit expressions of intent can be conveyed through wearable indicia (e.g., clothing, body branding, vehicle branding, . . . ). Such scenario belongs to the (offline; offline) realization-quadrant 230. In a wearable intent-compensation incentive model, an agent (e.g., agent 110) conveys intent explicitly by displaying (a) signs that label a user as a registered customer of service platform 120, (b) images of products the agent (e.g., agent 110) can be interested in buying, (c) specific advertisement on behalf of a merchant, and the like. Cameras, microphones, and various other sensors, which can be a part of an intent processing component 135 and can be distributed in real space (e.g., within cell 605) can capture indicia worn by the agent (e.g., agent 110) and content uttered (e.g., aural expression(s)) by the agent as well, an analysis component (e.g., component 304) can extract biometric features (e.g., voice characteristics, face structure, body type, . . . ) associated with the agent and identify him or her, upon successful identification the agent can receive a reward compensation (e.g., a direct payment, a sum of reward points, a specific coupon, . . . ) directly conveyed to a device (e.g., device 615) operated by the agent. As discussed above, based on the degree of confidence with which the agent's intent is determined from the wearable indicia, a service platform determined the magnitude of compensation. As an example, an agent that wears a garment with the legend “Want cheap, great tasting food” can be delivered coupons to his or her cellular phone, within an advertisement exposure model for compensation, for restaurants that offer affordable food known for its quality once the garment is detected and the agent is identified.

It is to be appreciated that multiple scenarios are possible in order to collect intent expressions through wearable indicia: (a) A camera is installed in an agent's vehicle and images are conveyed to intent processing component 135. In such scenario, the agent is clearly identified as the source of the images incoming from the specific camera or sensor. Indicia such as “Need a locksmith” can be clearly displayed on garment or hat. Intent is clearly identified, and compensation can be of the highest quality in view of the high level of confidence with which intent is determined. (b) Wearable indicia are captured within a merchant store. Determination of intent is trustworthy as the agent is in a specific merchant store, e.g., a coffee shop, possibly wearing garments with indicia like “Latte Lover,” or “Got Hot Chocolate?” Upon identification agent can receive a direct discount at the checkout time. (c) Agent walks in city streets and cameras deployed by service platform 120 capture wearable indicia like “Need a breakfast dive.” In this scenario, confidence on a determined intent is lower since the agent needs to be identified through analysis of images and sounds, which can be noisy. It is to be appreciated that garments or inks utilized to convey indicia can have specific optical properties, like light emission at a specific wavelength (e.g., fabric of garment is embedded with semiconductor quantum dots that fluoresce at a specific wavelength) that can be detected through CCD cameras deployed by service platform 120. If the wavelength is outside the visible region of the electromagnetic spectrum, more explicit, richer expressions can be set forth by an agent.

Moreover, collection of offline explicit and implicit expressions can facilitate a fully commercially adaptive store, wherein prices paid for merchandise by customers can depend on the various expressions of intent that the customers can convey. For example, a group of customers waking down the aisle of ethnic foods and comparing merchandise prices in a supermarket store can be detected to converse in Spanish, in addition at least one of the members of the group of customers can be determined to be a registered member of Hispanic origin of a service platform that maintains an intent-compensation customer price incentive; accordingly, said member of the group can receive an advertisement in her smart phone with a link to download a coupon for ingredients necessary for preparing meals with a Hispanic flavor. Similarly, in the same aisle, registered agents searching for ingredients to prepare an Indian meal can be delivered recipes for Indian meals directly to their PDAs. In a more general aspect of the illustrative supermarket store, each customer can receive customized compensation based on their expressed intent as detected through probes deployed throughout the store and conveyed to an intent processing component 120.

It is to be noted that the coupon-price adaptive store can be realized in the (online; online) realization quadrant 210, wherein compensation and associated advertisement can be delivered in accordance with aspects described herein and based on explicit or implicit (like web browsing habits) expression of intent conveyed to a service platform.

FIG. 6B illustrates an example system 650 in which either intent 115 or compensation 125, or both, are conveyed to an agent via agent-agent interaction. System 650 is similar to system 600 and like elements with like numerals in such system function in substantially the same manner. In system 650, registered agent 610 operating a registered device 615 relays either intent 115 or compensation 125 or both to agent 660 operating a device 665. A communication link 670, with substantially the same functional features as link 618, facilitates content relay of information or reward(s). In addition, information collection from and, at least partially, biometric recognition of agent 660 is performed by agent 610. It is to be noted that because information or reward(s) are relayed by a registered agent/device, neither agent 660 nor device 665 need be registered with service platform 120. Communication typically entails exchange of visual and aural indicia, wherein the exchange can be mediated by any pairwise combination of agents 610 and 660 and devices 615 and 665. It is to be appreciated that while the agent-agent interaction is illustrated with a set of two agents (e.g., agent 610 and agent 660), interaction can be established among more than two agents.

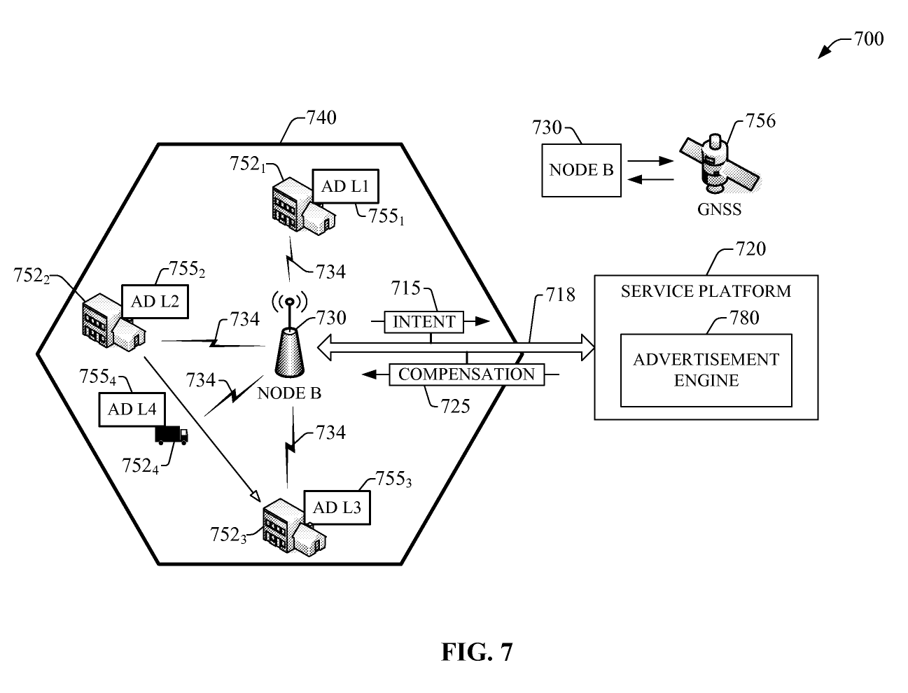

FIG. 7 illustrates an example system 700 that drives customer consumption through location-adjusted compensation in an intent-compensation price incentive scheme implemented by a service platform 720. In example system 700 a service platform 720 receives intent 715 and delivers compensation 725. Service platform 720 has substantially the same functionality of service platform 120, while intent 715 can be determined in substantially the same manner as intent 115, and compensation 725 can be generated, managed, and awarded in substantially the same manner as compensation 225. Intent 715 and compensation 725 are received and conveyed, respectively, through communication link 718. A base station 730, which can be operated by service platform 730 or an affiliated wireless service operator, receives intent and conveys compensation wirelessly via over-the-air links 734. In addition, node B 730 communicates with a global navigation satellite system (GNSS) 756, which provides location services to service platform 720 that facilitate locating a set of registered devices that pertain to a specific customer. It is to be appreciated that GNSS 756 operates in open sky; however, information received from GNSS 756 can be supplemented with information generated by node B 730 and additional disparate access points and cameras (which can be a part of information collection component (like component 263) residing in service platform 720) to generate indoor positioning information for a device (not shown) operated by a customer. As a customer moves within serving cell 740 as a result of, for example, commuting to work, visiting relatives, taking children to school, or going shopping, service platform 720 can collect multiple explicit and implicit expressions of intent, which can be processed and in response advertisement that is location-dependent can be conveyed to a registered device operated by the customer: Advertisements AD L1 755₁, AD L2 755₂, and AD L3 755₃ in respective locations 752₁, 752₂ and 752₃. Advertisements 7551-7553 can drive the customer to a specific retailer (e.g., 752₁) by presenting the customer with an advertisement carrying an associated compensation in response to the customer entering into a competitor retailer store (e.g., 752₂). Alternatively, or in addition, advertisement associated with a merchant can de displayed in a navigation system 7524 to a customer in response to a customer driving to either a competitor merchant. Moreover, advertisements in the navigation system can be presented with compensation originated from merchants located in the neighborhood of the customer's programmed destination.

It is to be noted that compensation offered through such implicit expressions of intent can be adjusted to various values depending on the degree of confidence with which intent 715 is extracted from the implicit expressions. A degree of confidence for an inferred intent can be determined by an intelligent component in service platform 720. The adjustments can be performed by a compensation component residing within service platform 720. Furthermore, in order to determine an adequate tone and compensation for the advertisement presented to a customer in various locations, the response of the customer to the advertisement can be probed through an ad response analysis component, like component 425, residing within service platform 720. Accordingly, a compensation “sweet spot” can be inferred by service platform 720 with a compensation sufficiently high to entice the customer to engage in a commercial transaction with a merchant or service provider affiliated with the service platform. Inference can be based on various metrics such as distance from customer to merchant store offering compensation, time of day the advertisement associated with the compensation is delivered (e.g., rush hour, low-traffic hour, weekday daytime or nighttime, weekend daytime or nighttime, . . . ).

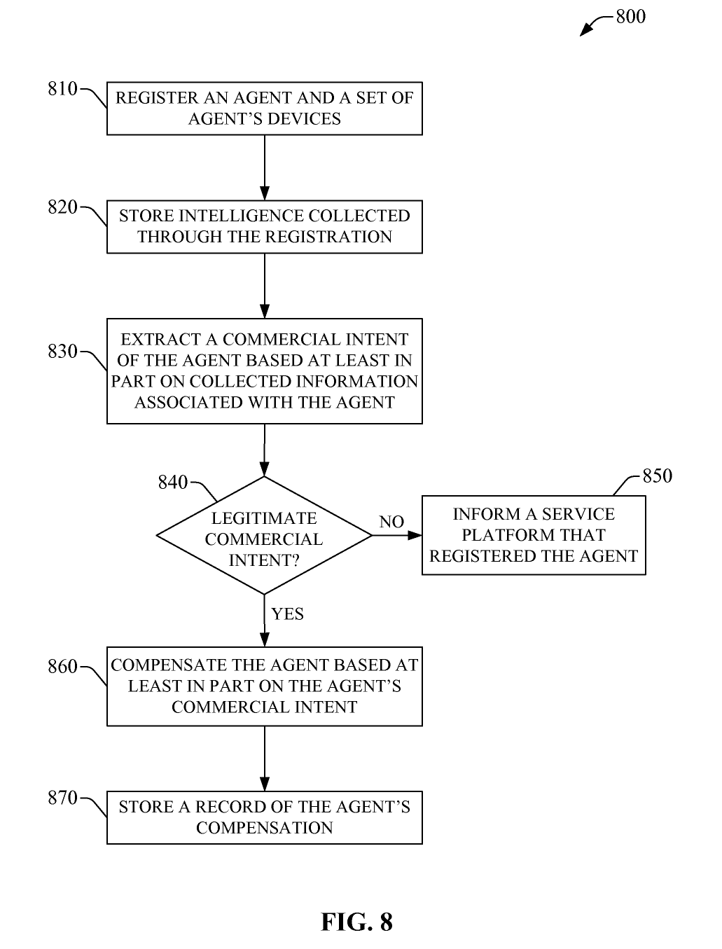

In view of the example systems, and associated aspects, presented and described above, methodologies for compensating either online or offline an agent in exchange for an agent's intent, conveyed either online or offline, that may be implemented in accordance with the disclosed subject matter can be better appreciated with reference to the flowcharts of FIGS. 8-12. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers.

FIG. 8 illustrates an example method 800 for compensating an agent in exchange of the agent's commercial intent. Generally, compensation is provided by a service platform that provides a service or merchandises a product. Service(s) or product(s) can be delivered online or offline. Similarly, agent's intent can be conveyed online or offline, gleaned from implicit or explicit expressions or actions. (FIG. 2 summarizes intent-compensation realizations.) At act 810, an agent and a set of devices that belong to the agent are registered. Typically registration is with a service platform with which the agent intends to conduct a commercial transaction. At act 820, information provided by the agent, or agent intelligence, is stored. Such information can facilitate intent determination, in particular in situations in which agent's intent is inferred through collection of implicit expressions of intent (e.g., standing in line in a movie theater, or waiting in the lobby of a restaurant, parking outside a supermarket store, etc.) At act 830, a commercial intent of the agent is extracted based at least in part on collected information associated with the agent. At act 840, the veracity of legitimacy of the agent's commercial intent is validated. When the validation act indicates intent is fraudulent, a service platform that has registered the agent is informed. Generally, the information can be utilized to flag the agent and collect further information associated with illicit intent, or in order to penalize the agent in future engagements with the service platform. Legitimate intent results in agent's compensation based at least in part on the agent's intent. At act 870, a record of the compensation is stored. The compensation record increases intelligence accumulated on the user, facilitates auditing claims associated with missed compensation, etc.

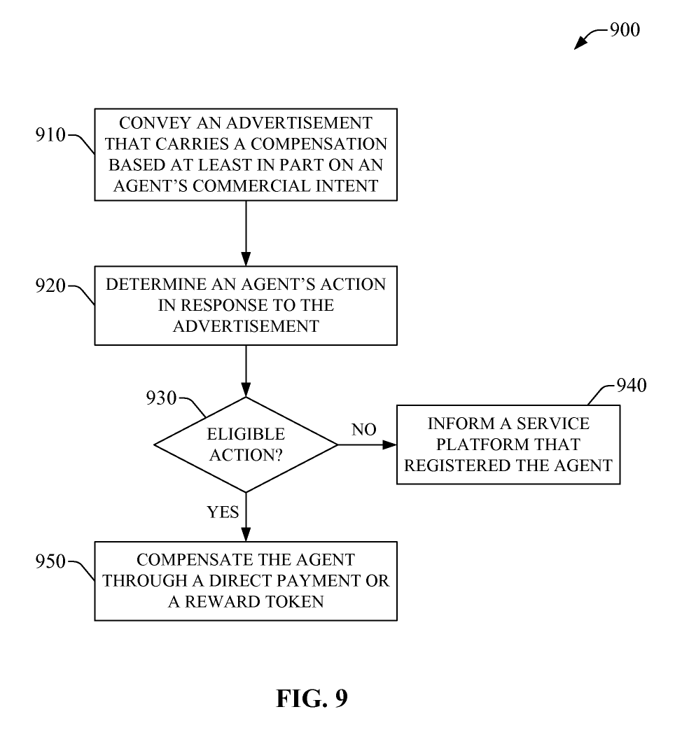

FIG. 9 presents a flowchart of an example method for compensating an agent through advertisement in exchange of agent's intent in transacting with a service platform. At act 910, an advertisement that carries compensation (e.g., Ad J 445ⱼ or Ad K 445_{K}) is conveyed, wherein the compensation is based at least in part on an agent's commercial intent. In an aspect, compensation is funded through advertisement spend originated by an advertisement engine (e.g., ad engine 180). The advertisement engine can be a part of a service platform with which the agent interacts commercially, can be a conglomerate of advertisers managed by an advertisement agency that manages and maintains the advertisement engine, or it can be a portion of a content, product or service provider affiliated with the service platform. It should be appreciated that either the advertisement agency or the affiliated provider can run business operations exclusively offline or exclusively online. Alternatively, or in addition, advertisers can be associated with online business operations. It is to be appreciated that regardless the nature of the business operations in connection with the advertisement engine, an advertisement management component can administer advertisement online or offline.

At act 920, an agent's action is determined in response to the conveyed advertisement. The advertisement can indicate the agent that an action is required in order to receive a compensation (e.g., advertisement-driven-action-to-compensation model). Alternatively, compensation can be delivered through advertisement exposure or advertisement instantiation (e.g., the agent opens a link to the advertisement, opens a message carrying the advertisement, received a call for a “sales pitch” advertisement, . . . ).

At act 930, the action is checked in order to determine whether the agent has engaged according to the advertisement model (e.g., exposure, instantiation, action) for compensation. When the agent fails to act accordingly, a service platform that registered the agent is informed at act 940. In an aspect, receiving such information provides the service platform to adjust or optimize advertisement content or delivery in order to promote agent lock-in with the action proposed in the advertisement. At act 950, an agent that performs an eligible action is compensated through either a direct payment (e.g., deposit in a bank account, retirement account, college savings account, credit card account, brokerage account, college/school/childcare tuition account, and so on), or via a reward token like reward points or point currency, digital goods or content, coupons for offline or online stores, and the like.

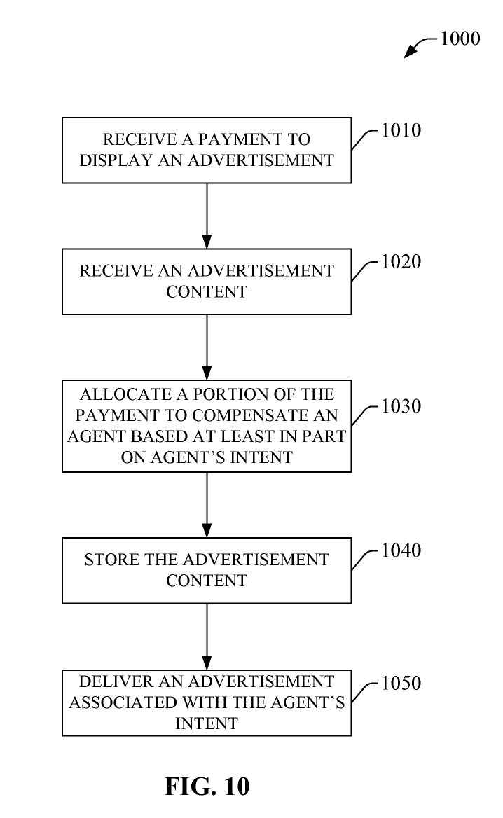

FIG. 10 presents a flowchart of an example method 1000 for presenting advertisement to an agent and funding compensation of the agent in return for the agent's intent in accordance with aspects of the subject innovation. At act 1010, a payment to display an advertisement is received. Generally, a service platform receives the payment. The service platform is not limited to operate commercially online or offline, and it can be associated with a variety of services and products; the latter can be accomplished through affiliated content (e.g., products, services) providers. At act 1020 advertisement content is received. The ad content need not be an advertisement product; instead, the content can be (1) a set of guidelines and expectations for an advertisement campaign; (2) customer intelligence, such as customer demographics and associated segmentation, research results from focus groups and polls, models and lift charts for direct messaging campaigns (e.g., direct mail, instant messaging, email), etc.; (3) elements known to be effective in locking-in target customers such as music, images, quotes, excerpt of speeches, and so on; (4) pilot, non-optimal advertisement campaigns; and so forth. At 1030, a portion of the payment is allocated to compensate an agent based at least in part on the agent's intent. At act 1040, the advertisement content is stored (e.g., in a memory component like ad content store 435). In an aspect, stored ad content can be utilized for ad campaign content and format optimization, e.g., via optimization component 415. At act 1050 an advertisement associated with the agent's intent is delivered. The advertisement can be delivered online or offline, with features optimized, or targeted, for a specific agent or for a specific device operated by the agent. Customization of advertisement can be accomplishment autonomously based on existing intelligence on the agent (e.g., information stored in agent intelligence 269).

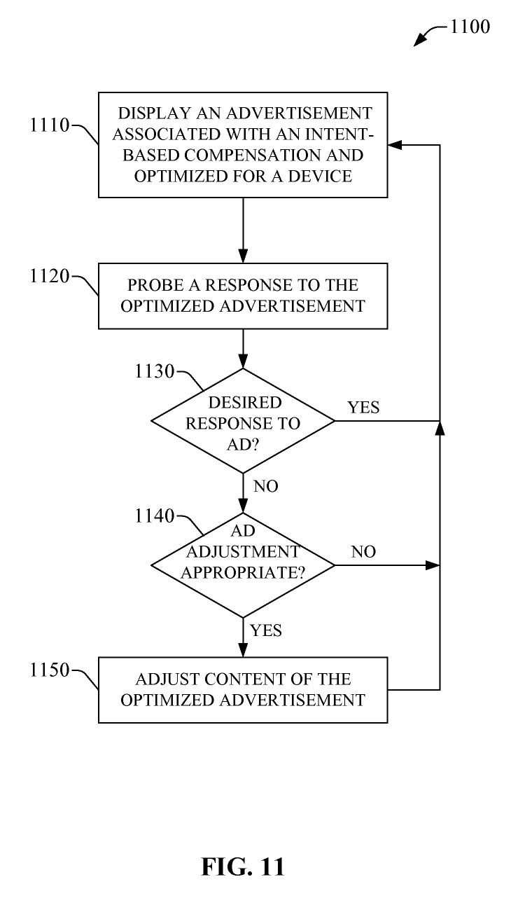

FIG. 11 is a flowchart of an example method 1100 for driving consumer behavior through advertisement in accordance with aspects described herein. At act 1110 an advertisement associated with an intent-based compensation, and optimized for a device, is displayed. The device can be a registered device that an agent utilizes to transact with a service platform (e.g., platform 120, platform 720). The service platform can present the agent with the advertisement, which can be extracted from an advertisement engine (e.g., ad engine 180). The advertisement can be displayed through a wired or wireless communication link. At act 1120 a response to the advertisement is probed. In an aspect, sensors deployed in the device that displays the advertisement can determine physiological changes in an agent exposed to the advertisement; namely, changes in eye movement pattern, pupil dilation level, facial expression, body temperature and perspiration levels. Such changes can reflect emotions elicited by the advertisement, and the emotions can conduct the agent to instantiate the advertisement, like for example following a link displayed in the ad, or engage in an action presented by the advertisement. Such sensors can be a part of an ad response analysis component such as component 425. At 1130, it is checked whether the advertisement caused a desired response (e.g., a transaction was conducted by an agent exposed to the ad as a result of the exposure). In the affirmative case, in an aspect, exposure to the advertisement was successful and an additional ad impression can be pursued by reenacting 1110. Conversely, it is evaluated at act 1140 whether adjustment of the advertisement is appropriate. In the affirmative case, content of the device-optimized advertisement is adjusted. The magnitude of the adjustment can be determined by an optimization component (e.g., component 415) based at least in part on analysis generated by the ad response component 425. After adjustment, the adjusted advertisement can be presented to the agent by reenacting 1110.

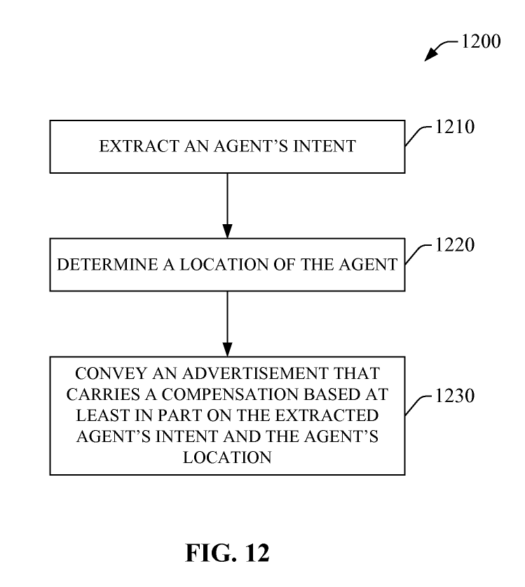

FIG. 12 is a flowchart of an example method 1200 for adaptively conveying advertisement to an agent based at least in part on the agent's intent and the agent's location. In an aspect, advertisement adaptation can be effected to bias an agent's response or to drive an agent to a specific consumption behavior. Advertisement can be delivered by a service platform (e.g., platform 720), and originated at least in part by an advertisement engine (engine 780), which can be a part of the service platform or it can be external to the service platform. At act 1210 intent of an agent is extracted. In an aspect, intent is extracted via an intent processing component (e.g., component 135) that can exploit artificial intelligence techniques and can collect explicit and implicit expression of intent as well as extrinsic information, such as agent's context (e.g., location, features of the location, and the like). The extracted intent typically reflects a commercial intent associated with a transaction with a service platform.

At act 1220 a location of the agent is determined. Location can be offline (e.g., a real space location) or online (e.g., a web-portal, a web-based game, a chat room, a blog). Offline location can be determined through location services that pinpoint the position of a device operated by an agent; the location services can include global navigation satellite systems such as GPS, Galileo, or GLONASS. Indoor locations can be determined through wireless access points deployed inside buildings; the access points provide wireless service to the device and can be managed by a service platform determining extracting the agent's intent or via an affiliated service provider.

At act 1230, an advertisement is conveyed; the advertisement carries a compensation based at least in part on the extracted agent's intent and agent's location. For example, an agent is playing a MMOG online and is trying to traverse territories that are foreign to the player in order to reach a specific village to finish a mission. A service platform hosting the MMOG can display an advertisement for maps of the territories with a link to a webpage where the maps can be downloaded at a discounted rate. When the player instantiates the advertisement by visiting the link, then additional advertisement related to the MMOG can be displayed and the player engaged in additional transactions.

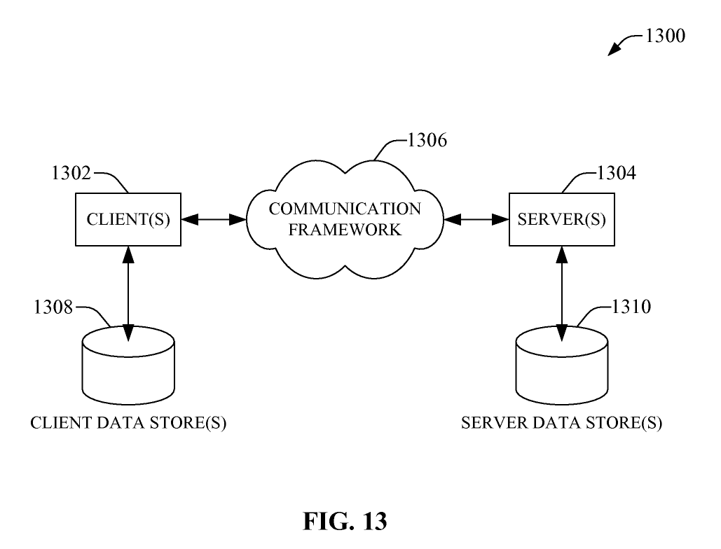

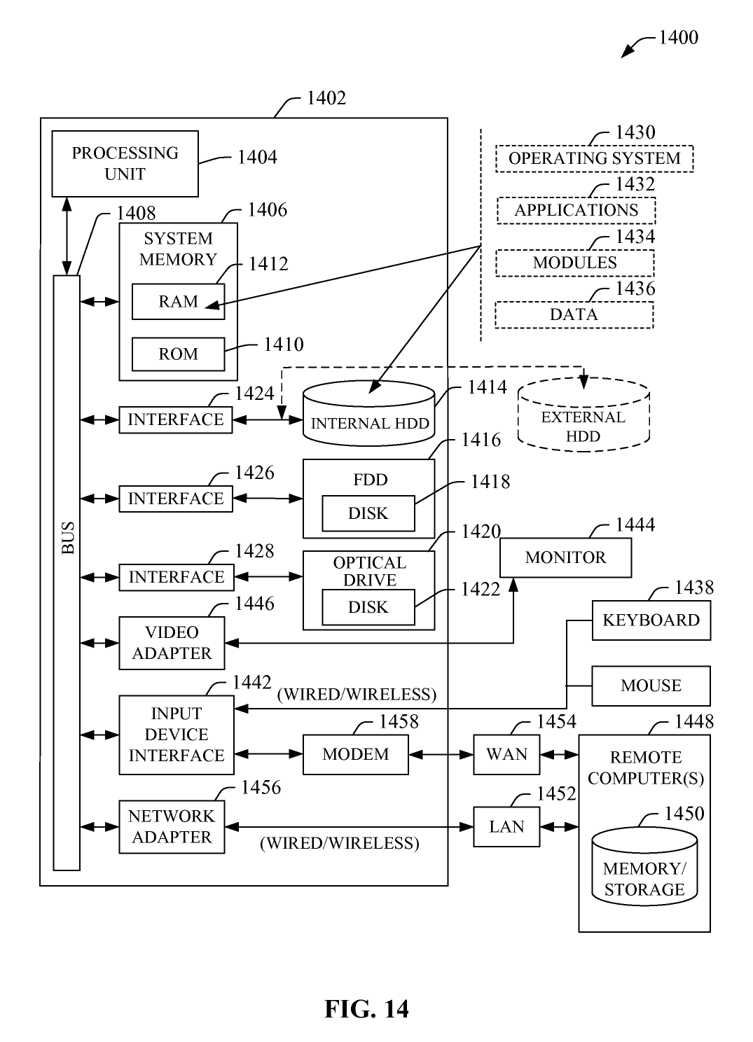

In order to provide additional context for various aspects of the subject specification, FIGS. 13 and 14 and the following discussions are intended to provide a brief, general description of suitable computing environments 1300 and 1400 in which the various aspects of the specification can be implemented. While the specification has been described above in the general context of computer-executable instructions that may run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

FIG. 13 illustrates a schematic block diagram of a computing environment in accordance with the subject specification. The system 1300 includes one or more client(s) 1302. The client(s) 1302 can be hardware and/or software (e.g., threads, processes, computing devices). The client(s) 1302 can house cookie(s) and/or associated contextual information by employing the specification, for example.

The system 1300 also includes one or more server(s) 1304. The server(s) 1304 can also be hardware and/or software (e.g., threads, processes, computing devices). The servers 1304 can house threads to perform transformations by employing the specification, for example. One possible communication between a client 1302 and a server 1304 can be in the form of a data packet adapted to be transmitted between two or more computer processes. The data packet may include a cookie and/or associated contextual information, for example. The system 1300 includes a communication framework 1306 (e.g., a global communication network such as the Internet) that can be employed to facilitate communications between the client(s) 1302 and the server(s) 1304.

Communications can be facilitated via a wired (including optical fiber) and/or wireless technology. The client(s) 1302 are operatively connected to one or more client data store(s) 1308 that can be employed to store information local to the client(s) 1302 (e.g., cookie(s) and/or associated contextual information). Similarly, the server(s) 1304 are operatively connected to one or more server data store(s) 1310 that can be employed to store information local to the servers 1304.

In FIG. 14, the example environment 1400 for implementing various aspects of the specification includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures may also be employed as the processing unit 1404.

The system bus 1408 can be any of several types of bus structure that may further interconnect to a memory bus (with or without a memory controller), a peripheral bus, and a local bus using any of a variety of commercially available bus architectures. The system memory 1406 includes read-only memory (ROM) 1410 and random access memory (RAM) 1412. A basic input/output system (BIOS) is stored in a non-volatile memory 1410 such as ROM, EPROM, EEPROM, which BIOS contains the basic routines that help to transfer information between elements within the computer 1402, such as during start-up. The RAM 1412 can also include a high-speed RAM such as static RAM for caching data.

The computer 1402 further includes an internal hard disk drive (HDD) 1414 (e.g., EIDE, SATA), which internal hard disk drive 1414 may also be configured for external use in a suitable chassis (not shown), a magnetic floppy disk drive (FDD) 1416, (e.g., to read from or write to a removable diskette 1418) and an optical disk drive 1420, (e.g., reading a CD-ROM disk 1422 or, to read from or write to other high capacity optical media such as the DVD). The hard disk drive 1414, magnetic disk drive 1416 and optical disk drive 1420 can be connected to the system bus 1408 by a hard disk drive interface 1424, a magnetic disk drive interface 1426 and an optical drive interface 1428, respectively. The interface 1424 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1402, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the example operating environment, and further, that any such media may contain computer-executable instructions for performing the methods of the specification.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. It is appreciated that the specification can be implemented with various commercially available operating systems or combinations of operating systems.

A user can enter commands and information into the computer 1402 through one or more wired/wireless input devices, e.g., a keyboard 1438 and a pointing device, such as a mouse 1440. Other input devices (not shown) may include a microphone, an IR remote control, a joystick, a game pad, a stylus pen, touch screen, or the like. These and other input devices are often connected to the processing unit 1404 through an input device interface 1442 that is coupled to the system bus 1408, but can be connected by other interfaces, such as a parallel port, an IEEE 1394 serial port, a game port, a USB port, an IR interface, etc.

A monitor 1444 or other type of display device is also connected to the system bus 408 via an interface, such as a video adapter 1446. In addition to the monitor 444, a computer typically includes other peripheral output devices (not shown), such as speakers, printers, etc.

The computer 1402 may operate in a networked environment using logical connections via wired and/or wireless communications to one or more remote computers, such as a remote computer(s) 1448. The remote computer(s) 1448 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1450 is illustrated. The logical connections depicted include wired/wireless connectivity to a local area network (LAN) 1452 and/or larger networks, e.g., a wide area network (WAN) 1454. Such LAN and WAN networking environments are commonplace in offices and companies, and facilitate enterprise-wide computer networks, such as intranets, all of which may connect to a global communications network, e.g., the Internet.

When used in a LAN networking environment, the computer 1402 is connected to the local network 1452 through a wired and/or wireless communication network interface or adapter 1456. The adapter 1456 may facilitate wired or wireless communication to the LAN 1452, which may also include a wireless access point disposed thereon for communicating with the wireless adapter 1456.

When used in a WAN networking environment, the computer 1402 can include a modem 1458, or is connected to a communications server on the WAN 1454, or has other means for establishing communications over the WAN 1454, such as by way of the Internet. The modem 1458, which can be internal or external and a wired or wireless device, is connected to the system bus 1408 via the serial port interface 1442. In a networked environment, program modules depicted relative to the computer 1402, or portions thereof, can be stored in the remote memory/storage device 1450. It will be appreciated that the network connections shown are example and other means of establishing a communications link between the computers can be used.

The computer 1402 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks [e.g., compact disk (CD), digital versatile disk (DVD) . . . ], smart cards, and flash memory devices (e.g., card, stick, key drive . . . ).

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the terms “includes,” “has,” “possesses,” and the like are used in either the detailed description or the claims, such term is intended to be inclusive in a manner similar to the term “comprising” as “comprising” is interpreted when employed as a transitional word in a claim.

1. A system to compensate an agent in exchange for the agent's intent in transacting with a service platform, the system comprising:
a component that registers an agent and a set of devices operated by the agent;
a component that extracts intent from received information associated with the registered agent; the information received at least in one of an offline domain or an online domain;
a component that compensates the agent via advertisement spend in return for the extracted agent's intent.

2. The system of claim 1, further comprising a storage component that retains intelligence on a registered agent.

3. The system of claim 2, further comprising an advertisement spend management component that allocates an advertisement payment towards compensation.

4. The system of claim 2, further comprising an advertisement management component that displays an advertisement that is associated with the extracted intent and carries a compensation.

5. The system of claim 4, wherein the advertisement is displayed in at least one of an offline domain or an online domain.

6. The system of claim 4, wherein the compensation is delivered through an agent's action elicited through the advertisement.

7. The system of claim 4, wherein the advertisement management component includes:
an advertisement content store that retains advertisement content;
a component that optimizes an advertisement's content in accordance with the intelligence stored on the registered agent;
a component that optimizes an advertisement's format in accordance with at least one device in the set of registered devices; and
a component that analyzes a registered agent's response to an optimized advertisement.

8. The system of claim 1, the component that extracts intent further comprises:
an information collection component that gathers at least one of a set of implicit expressions or a set of explicit expressions;
a privacy component that vets the gathered expressions according to an agent's privacy profile; and
an analysis component that processes the vetted expressions and infers an intent.

9. The system of claim 8, wherein the set of implicit expressions includes visual and aural expressions, and the set of explicit expressions comprises wearable indicia.

10. The system of claim 1, the component that compensates the registered agent includes:
a component that accounts awarded compensation to a registered agent;
an antifraud component that mitigates fraudulent compensation; and
a component that retains compensation records.

11. A method for ubiquitous intent-based compensation of an agent in exchange for the agent's intent in transacting with a service platform, the method comprising:
registering an agent;
extracting a commercial intent of the registered agent through at least one of a set of offline expressions or a set of online expressions;
assessing the legitimacy of the extracted commercial intent;
compensating the registered agent in exchange for the agent's legitimate commercial intent.

12. The method of claim 11, further comprising storing a record of the registered agent's compensation.

13. The method of claim 11, further comprising registering a set of devices operated by the agent.

14. The method of claim 13, further comprising storing agent's intelligence through the registration process.

15. The method of claim 13, compensating the registered agent in exchange for the agent's legitimate commercial intent further comprising:
conveying an advertisement that carries a compensation based at least in part on the agent's commercial intent;
determining an agent's action in response to the advertisement;
determining the agent's action is an eligible action based at least in part on the advertisement's content; and
compensating the agent through at least one of a direct payment or a reward token.

16. The method of claim 15, conveying an advertisement that carries a compensation based at least in part on the agent's commercial intent further comprising:
receiving a payment to display the advertisement;
allocating a portion of the payment to compensate an agent based at least in part on an agent's commercial intent; and
delivering an adversing associated with the agent's commercial intent.

17. The method of claim 16, further comprising:
receiving an advertisement content;
storing the advertising content; and
optimizing the advertisement content for the set of registered devices operated by the agent; and
optimizing an advertisement format for the set of devices operated by the agent.

18. The method of claim 13, further comprising:
determining the agent's location; and
conveying an advertisement that carries a compensation based at least in part on the agent's location.

19. The method of claim 18, wherein the agent's location is at least one of an offline position or an online location.

20. A method for driving an agent's commercial transaction through intent-based advertisements; the method comprising:
displaying an advertisement associated with an intent-based compensation and optimized for an agent's device, wherein the advertisement is displayed in at least one of an offline domain or an online domain;
probing an agent's response to the optimized advertisement; and
adjusting the compensation associated with the advertisement according the agent's response.
